(19) United States
(12) Patent Application Publication
(10) Pub. No.: US 2009/0114143 A1
(43) Pub. Date: May 7, 2009

(54) NURSING BOTTLE WITH NURSING TIME INDICATING DEVICE

(76) Inventor: Kuo-Liang SHIH, Taipei (TW)

Correspondence Address: RABIN & Berdo, PC, 1101 14TH STREET, NW, SUITE 500, WASHINGTON, DC, 20005, US

(21) Appl. No.: 11/934,506

(22) Filed: Nov. 2, 2007

(51) Int. Cl. B65D 85/72; A61J 9/00

(52) U.S. Cl. 116/2; 215/11.1

(57) ABSTRACT

A nursing bottle with a nursing time indicating device, which includes a bottle body, a bottle cap screwed to a mouth of the bottle body, a protective cap rotatably covered over the bottle cap, and a nursing time indicating device including an indicating sign and a scale structure separately but correspondingly provided on the outer surfaces of two different components of the nursing bottle that could be turned relative to each other. When the two components bearing the nursing time indicating device are rotated relative to each other to align the indicating sign with a desired position of the scale structure, a specific time may be indicated. A reminder, such as a phrase, is provided next to the indicating sign to clearly define the meaning of the specific time indicated by the indicating sign and the scale structure. Therefore, a nurse may conveniently notice the correct time for nursing an infant.

### FIELD OF THE INVENTION

The present invention relates to a nursing bottle, and more particularly to a nursing bottle with nursing time indicating device, so that a nurse may at all times know the correct time to feed an infant.

### BACKGROUND OF THE INVENTION

A conventional nursing bottle is integrally formed from a safety plastic material to have a bottle body defining an internal receiving space for holding an amount of milk therein. A protective cap is screwed to a top of the bottle body, and a nipple is upward extended through a center of the protective cap. The nipple is provided at a top center with a tiny aperture, through which an infant sucks milk from the nursing bottle. The bottle body is longitudinally provided at one side with a plurality of equally spaced horizontal scales, and graduations are shown next to the horizontal scales to indicate different volumes, so that a nurse may easily control and know the volume of milk having been prepared for nursing.

In the growing process of an infant, the total amount of milk fed to the infant is generally fixed; yet, there is an inverse relationship between the nursing volume each time and the total times of nursing each day. For instance, when the infant drinks a small amount of milk each time, the total times of nursing per day must be increased. On the contrary, when the infant drinks a larger amount of milk each time, the total times of nursing per day must be reduced. A nurse has to calculate the time intervals of nursing according to the total times of nursing each day. As the infant grows, the total feeding amount is gradually increased, and the nursing volume each time and the total times of nursing each day must also be changed with the increase of the total feeding amount. Moreover, the nursing volume each time and the total times of nursing per day must also be adjusted according to the infant's appetite. In a normal condition, an infant would feel satisfied after sufficient milk intake and fall asleep quietly for 2 to 4 hours. In the event when the fed infant keeps on crying or the infant starts to cry even before the next nursing time, it might mean that there is some other factors causing the infant feeling uncomfortable; factors such as a wet diaper that brings the infant discomfort.

In the modern society, most parents and/or nurses are so busy that they frequently forget to feed the infant on time, leaving the infant in hunger. As a result, when the infant cries, the parents or the nurse cannot be certain about why the infant is crying; thus, the parents or the nurse will have to check the possible reasons such as a wet diaper, an interrupted nursing, and etc. The conventional nursing bottle is only provided on the bottle body with means for measuring the volume or the temperature of the milk in the bottle; however, the parents or the nurses are not able to find out from the milk remained in the nursing bottle that exactly when the last time the infant was fed and/or the next time the infant needs to be fed.

### SUMMARY OF THE INVENTION

A primary object of the present invention is to provide a nursing bottle that is provided with a nursing time indicating device for indicating the scheduled time in reminding a nurse the correct time for feeding an infant.

Another object of the present invention is to provide a nursing bottle that is provided with a nursing time indicating device to clearly show a time reference based on which a nurse can easily determine the next time to feed an infant without the risk of repeated nursing or obliviousness of feeding the infant.

To achieve the above and other objects, the nursing bottle with a nursing time indicating device according to the present invention includes a bottle body, a bottle cap screwed to a mouth of the bottle body, a protective cap rotatably covered over the bottle cap, and a nursing time indicating device including an indicating sign and a scale structure separately provided on the outer surfaces of any two different components of the nursing bottle at corresponding positions. When the two components bearing the nursing time indicating device are rotated relative to each other to align the indicating sign with a desired position of the scale structure, a specific time may be indicated.

A ring member may be further provided between the bottle body and the bottle cap. When the bottle cap is tightly screwed to the mouth of the bottle body, the ring member may be immovably held in place on the bottle body. The indicating sign and the scale structure may be separately provided on the protective cap and the ring member at corresponding positions. The ring member may be further provided at two diametrically opposite positions with two handles.

In one embodiment, the indicating sign and the scale structure are separately provided on the protective cap and the bottle cap at corresponding positions.

In another embodiment, the indicating sign and the scale structure are separately provided on the protective cap and the bottle body at corresponding positions.

The indicating sign may be an arrow in shape, and has a reminder, such as a reminding phrase, provided next to the arrow.

The scale structure may include 24 longer parallel line segments equally spaced along a circumferential surface on one component of the nursing bottle to represent 24 hours, and three shorter parallel line segments equally spaced in between any two adjacent longer line segments to divide a space between the two longer line segments into four subspaces to represent a quarter each. By aligning the indicating sign with one of the line segments, a specific time may be indicated.

The bottle body is longitudinally provided on one side with a plurality of parallelly arranged horizontal scales, and bottle volume measuring graduations are provided corresponding to the horizontal scales and arranged in an ascending order from bottom to top, so that a nurse may easily know from the graduations the correct volume of milk contained in the nursing bottle.

In a preferred embodiment, the indicating sign and the scale structure are integrally formed on the nursing bottle during manufacturing thereof. Alternatively, the indicating sign and the scale structure may be stickers attached to the nursing bottle.

In an ideal embodiment of the present invention, a nursing bottle with nursing time indicating device includes a bottle body defining a predetermined capacity, a bottle cap screwed to a mouth of the bottle body, a protective cap rotatably covered over the bottle cap, a ring member located between the bottle body and the bottle cap, and a nursing time indicating device including an indicating sign and a scale structure separately provided on outer surfaces of the nursing bottle and the ring member at the corresponding positions. The indicating sign may be aligned with a desired position of the scale structure to represent a specific time.

### BRIEF DESCRIPTION OF THE DRAWINGS

The structure and the technical means adopted by the present invention to achieve the above and other objects can be best understood by referring to the following detailed description of the preferred embodiments and the accompanied drawings, wherein

FIG. 1 is a perspective view of a nursing bottle with nursing time indicating device according to a first embodiment of the present invention;

FIG. 2 is an exploded view of FIG. 1;

FIG. 3 shows the manner of setting the nursing time indicating device on the nursing bottle of FIG. 1;

FIG. 4 is a perspective view of a nursing bottle with a nursing time indicating device according to a second embodiment of the present invention;

FIG. 5 is an exploded view of FIG. 4;

FIG. 6 shows the manner of setting the nursing time indicating device on the nursing bottle of FIG. 4;

FIG. 7 shows a third embodiment of the present invention;

FIG. 8 shows a fourth embodiment of the present invention;

FIG. 9 is a perspective view of a nursing bottle with a nursing time indicating device according to a fifth embodiment of the present invention;

FIG. 10 is an exploded view of FIG. 9;

FIG. 11 shows the manner of setting the nursing time indicating device on the nursing bottle of FIG. 9;

FIG. 12 shows a sixth embodiment of the present invention;

FIG. 13 shows a seventh embodiment of the present invention;

FIG. 14 shows an eighth embodiment of the present invention;

FIG. 15 shows a ninth embodiment of the present invention;

FIG. 16 shows a tenth embodiment of the present invention; and

FIG. 17 shows an eleventh embodiment of the present invention.

### DETAILED DESCRIPTION OF THE PREFERRED EMBODIMENTS

The present invention relates to a nursing bottle, on any two different components of which an indicating sign and a scale structure may be separately provided at corresponding positions to enable an indication of specific information about nursing time.

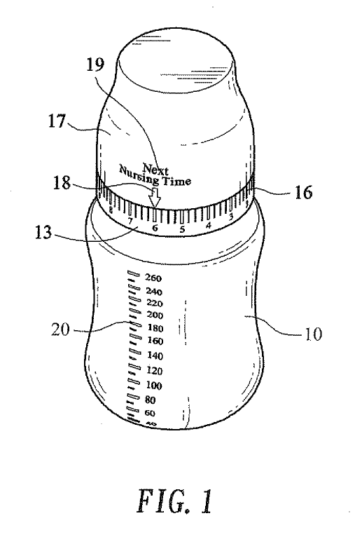

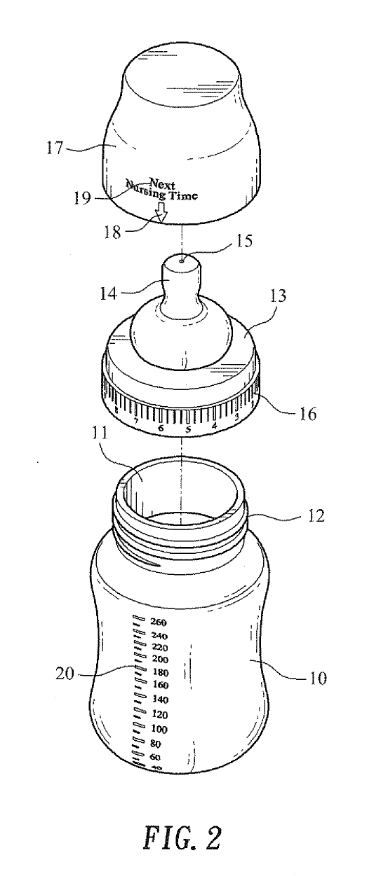

Please refer to FIGS. 1 and 2 in the assembled and exploded perspective views, respectively, of a nursing bottle with a nursing time indicating device according to the first embodiment of the present invention. As shown, the nursing bottle includes a bottle body 10 made of a heat-resistant plastic material, a silicon plastic material, or a glass material to define an internal receiving space. The bottle body 10 has an open top forming a mouth 11 and a closed bottom. The mouth 11 is reduced in diameter to form a neck that is externally provided with a plurality of screw threads 12. An internally threaded bottle cap 13 is screwed to the externally threaded mouth 11, and a nipple 14 having an aperture 15 is fixedly connected to a central opening of the bottle cap 13. The bottle cap 13 is provided on an outer circumferential surface with a scale structure 16. A protective cap 17 defining a predetermined internal space is movably closed over the bottle cap 13, so that the nipple 14 may be located in and covered by the protective cap 17. The protective cap 17 is provided on an outer surface at a position closer to the bottle cap 13 with an indicating sign 18. The scale structure and the indicating sign together constitute a nursing time indicating device.

A reminder 19 is further provided next to the indicating sign 18 to express the meaning of the specific time indicated by the aligned indicating sign and scale structure. The form or content of the reminder 19 may vary with the actual need in the application of the nursing bottle. In the illustrated first embodiment, the reminder 19 is a phrase “next nursing time”. Alternatively, the reminder 19 may be a phrase “current nursing time” or any other desired contents.

In a feasible embodiment, the scale structure 16 includes 24 longer parallel line segments equally spaced along the outer circumferential surface of the bottle cap 13 to represent 24 hours, and three shorter parallel line segments between any two adjacent longer line segments to divide a space in between the two longer line segments into four subspaces to represent a quarter each. By aligning the indicative sign to one of the line segments, a specific time may be indicated.

The bottle cap 13 is provided along an upper outer periphery with an annular end surface, and the protective cap 17 has a lower rim adapted to fitly be in contact with and accordingly be supported on the annular end surface of the bottle cap 13 to keep a smooth and level outer surface at the joint of the connected protective cap 17 and bottle cap 13. It is noted the protective cap 17 is rotatably covered on the bottle cap 13.

The bottle body 10 is longitudinally provided on one side with a plurality of parallelly arranged horizontal scales 20. Bottle volume measuring graduations are correspondingly provided next to the scales and arranged in an ascending order from bottom to top, so that a user may easily know the volume of the milk contained in the nursing bottle.

The scale structure 16 and the indicating sign 18 may be integrated with the nursing bottle in the manufacturing process. Alternatively, the scale structure 16 and the indicating sign 18 may be provided on a conventional nursing bottle at desired positions by printing, or attaching a paper strip, a tape, or a sticker to the bottle. It is understood that the above described ways to provide the scale structure 16 and the indicating sign 18 are only some feasible examples but to intend to limit the present invention.

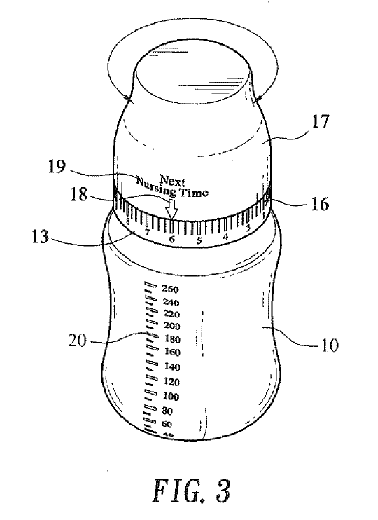

In referring to FIG. 3. When a user has fed milk to an infant using the nursing bottle shown in FIG. 1 the protective cap 17 may be adjusted/turned to align the indicating sign 18 thereon with one of the line segments of the scale structure 16 on the outer circumferential surface of the bottle cap 13 to indicate the next correct feeding time. With the help of the reminder 19, the user may easily know the exact time for the next scheduled nursing time, particularly when the user is busy and has forgotten to nurse the infant. With the nursing time indicating device provided on the nursing bottle, a user may easily find out the next time to nurse an infant; in another word, an infant may be timely fed without being ignored or over fed.

For example, when the nursing bottle has 150 ml of milk prepared therein, and the infant should be fed 30 ml each time at intervals of three hours, the user may, after the first time of nursing, turn the protective cap 17 to have the indicating sign 18 to align with one desired line segment of the scale structure 16 to indicate a desired time point 3 hours after the current feeding. In the event of the infant crying before the indicated time for the next nursing, it is possible the infant feels discomfort due to a wet diaper or other reasons instead of being hungry. Therefore, when the infant cries, the user could take proper measures without making incorrect judgment.

By changing the content of the reminder 19, the scale structure 16 and the indicating sign 18 on the nursing bottle of the present invention may be applied in different conditions. For example, the reminder 19 may be changed to be read as “last nursing time” in reminding the user the time when infant was last fed. The nursing bottle with nursing time indicating device of the present invention is particularly useful when there are more than one person who takes care of the infant in turn, because the scale structure 16, the indicating sign 18, and the reminder 19 together conveniently provide a uniform and correct information about the next nursing time to all those who are taking care of the infant.

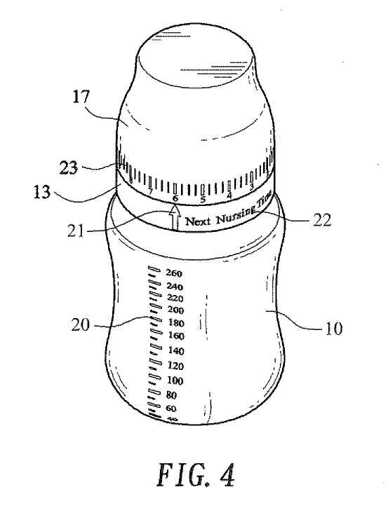

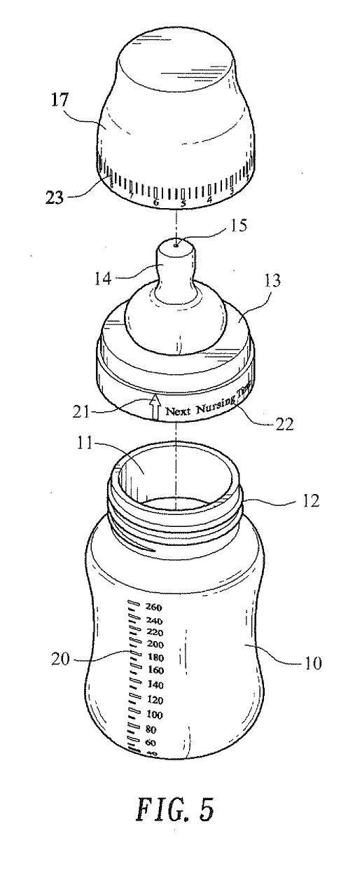

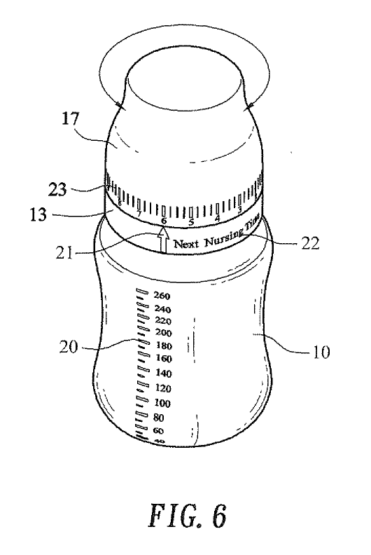

FIGS. 4 to 6 illustrate a nursing bottle with nursing time indicating device according to a second embodiment of the present invention. As shown, the nursing bottle in the second embodiment is structurally similar to the first embodiment, except that an indicating sign 21 is provided on the outer circumferential surface of the bottle cap 13 and a scale structure 23 is provided along an outer side of the rim of the protective cap 17. When the protective cap 17 is turned relative to the bottle cap 13, the scale structure 23 is turned at the same time to align one of the desired line segments of the scale structure 23 with the indicating sign 21 to indicate the specific nursing time information.

In the second embodiment, a reminder 22 may be further provided next to the indicating sign 21.

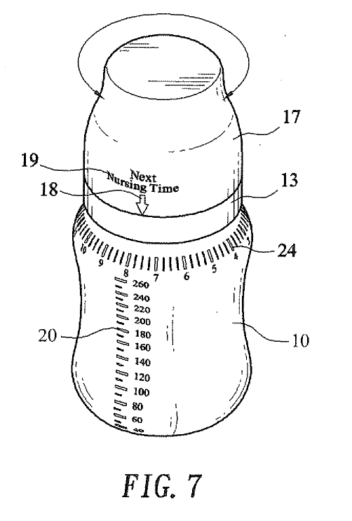

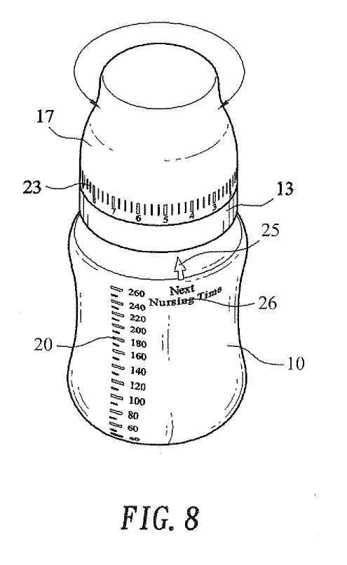

FIGS. 7 and 8 show a third and a fourth embodiment of the present invention, respectively, both of which employ similar design concept of the previous embodiments to provide a nursing indicating device on the protective cap 17 and the bottle body 10. More particularly, in the third embodiment shown in FIG. 7, an indicating sign 18 and a reminder 19 are provided on the protective cap 17, and a scale structure 24 is provided on an outer surface of the bottle body 10 at a position corresponding to the protective cap 17. Also, in the fourth embodiment shown in FIG. 8, a scale structure 23 is provided on the protective cap 17 and an indicating sign 25 and a reminder 26 are provided on the outer surface of the bottle body 10 at positions corresponding to the protective cap 17.

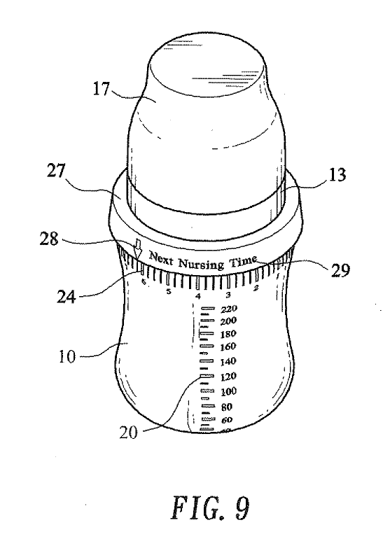

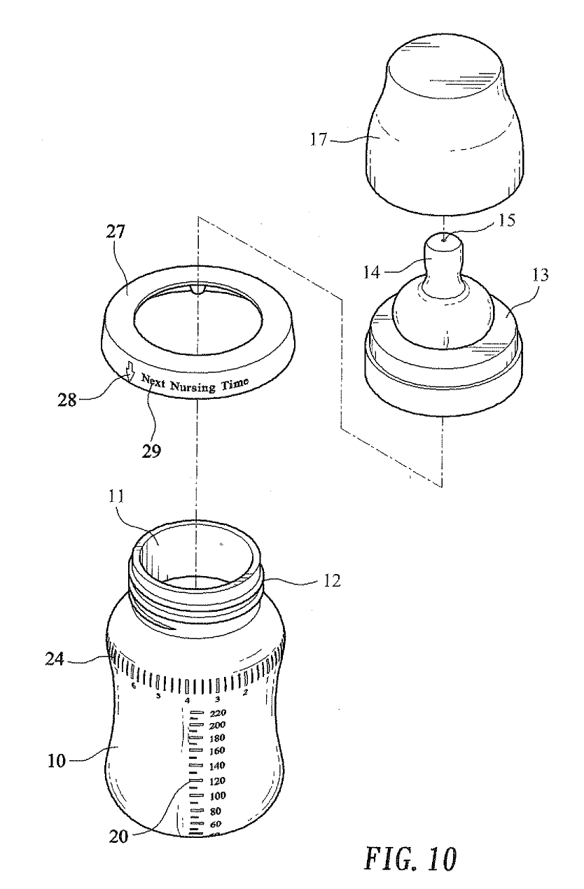

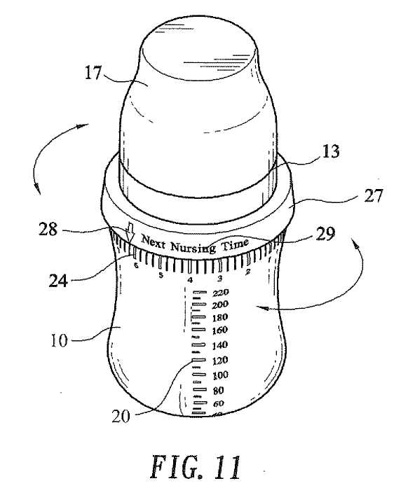

FIGS. 9 to 11 illustrate a nursing bottle with a nursing time indicating device according to a fifth embodiment of the present invention. The nursing bottle in the fifth embodiment is structurally similar to the previous embodiments, except for a ring member 27 that is further set around an upper part of the bottle body 10 with the externally threaded mouth 11 upward projected from the ring member 27. In this embodiment, the bottle cap 13 is tightly screwed to the mouth 11 to firmly hold the ring member 27 that is below the mouth 11 in place.

An indicating sign 28 and a reminder 29 are provided on an outer circumferential surface of the ring member 27; a scale structure 24 is provided around the bottle body 10 right below the ring member 27.

The bottle cap 13 is tightly screwed to the mouth 11 after the ring member 27 has been set to align the indicating sign 28 of the desired line segment of the scale structure 24. This would result in having the ring member 27 immovably held in between the bottle body 10 and the bottle cap 13 to enable a correct indication of the last or next nursing time.

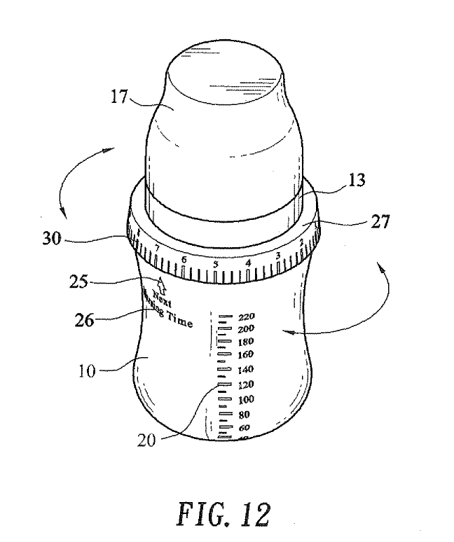

FIGS. 12 to 16 sequentially show a sixth, a seventh, an eighth, a ninth, and a tenth embodiment of the present invention. These embodiments are derived from the same design concept for the fifth embodiment shown in FIG. 9. As shown in FIGS. 12 to 16, the scale structure and the indicating sign of the nursing time indicating device may be separately but correspondingly provided on any two of the bottle body 10, the bottle cap 13, the protective cap 13, and the ring member 27 to achieve/obtain the same effect of a convenient and correct indication/reading of the last or next nursing time.

In the sixth embodiment shown in FIG. 12, an indicating sign 25 and a reminder 26 are provided on the bottle body 10, while a scale structure 30 is provided on the ring member 27. To use the nursing time indicating device, the bottle cap 13 needs to be loosen first, follow by an adjustment of the ring member 27 for the indicating sign 25 on the bottle body 10 to align with the desired line segment of the scale structure 30. Finally, the bottle cap 13 should be tightened again in order to hold the ring member 27 immovably in place.

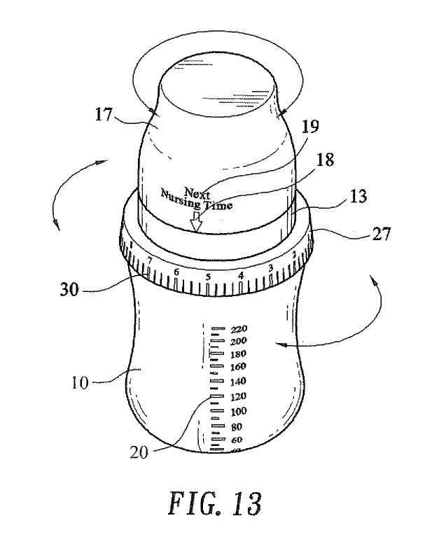

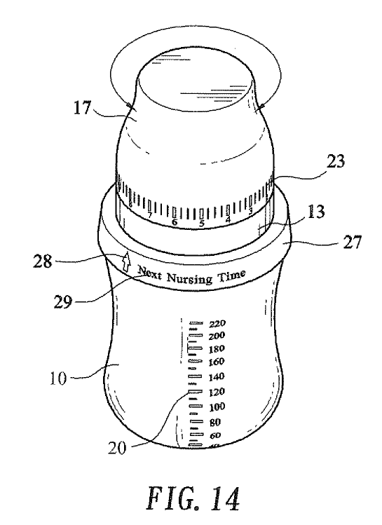

In the seventh embodiment shown in FIG. 13, an indicating sign 18 and a reminder 19 are provided on the protective cap 17, and a scale structure 30 is provided on the ring member 27. In the eighth embodiment shown in FIG. 14, a scale structure 23 is provided on the protective cap 17, and an indicating sign 28 and a reminder 29 are provided on the ring member 27. In both the seventh and the eighth embodiment, the indicating sign could be aligned with the desired line segment of the scale structure by turning the protective cap 17.

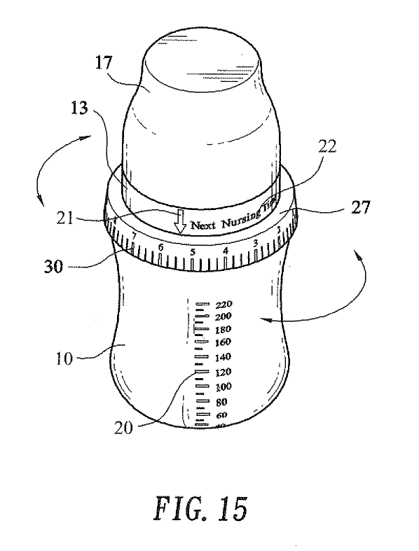

In the ninth embodiment shown in FIG. 15, an indicating sign 21 and a reminder 22 are provided on the bottle cap 13, and a scale structure 30 is provided on the ring member 27. To set the required nursing time, the bottle cap 13 needs to be slightly loosened first in allowing the ring member 27 to be freely turned and adjusted. Then, adjust the ring member 27 for the indicating sign 21 on the bottle cap 13 to align with the desired line segment of the scale structure 30. Last, tighten the bottle cap 13 again to hold the ring member 27 immovably in place.

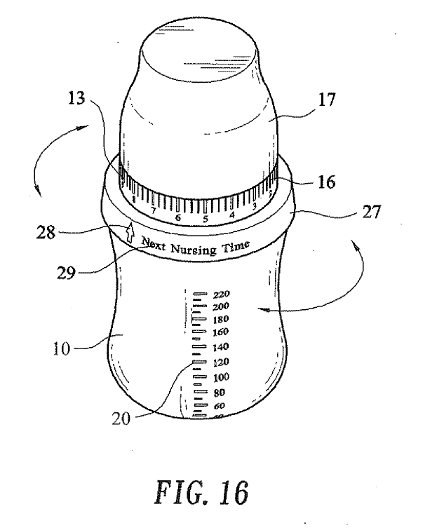

In the tenth embodiment shown in FIG. 16, an indicating sign 28 and a reminder 29 are provided on the ring member 27, and a scale structure 16 is provided on the bottle cap 13. In this embodiment, the required nursing time may be set in the same manner as in the ninth embodiment simply by turning the ring member 27.

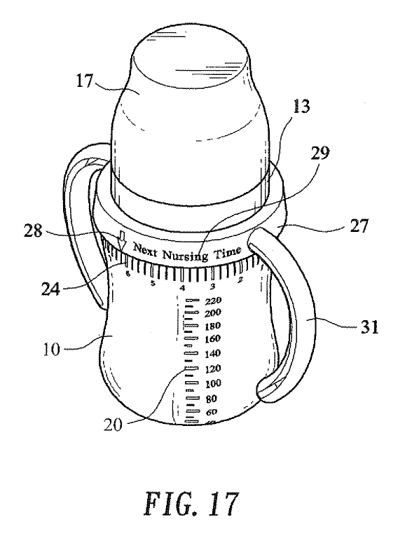

FIG. 17 shows an eleventh embodiment of the present invention that is derived from the fifth embodiment shown in FIG. 9. Two handles 31 sideward extend from two diametrically opposite sides of the ring member 27, so that an infant whom has grown big enough may hold the nursing bottle on the two handles 31. Of course, the handles 31 may also be applied to any one of the previous embodiments, so that the nursing bottle with the nursing time indicating device according to the present invention is not only helpful for a nurse to set and remember the correct time of next/last nursing, but also applicable to somewhat older infants.

The present invention has been described with some preferred embodiments thereof and it is understood that many changes and modifications in the described embodiments can be carried out without departing from the scope and the spirit of the invention that is intended to be limited only by the appended claims.

1. A nursing bottle with a nursing time indicating device, comprising a bottle body defining a predetermined capacity, a bottle cap screwed to a mouth of the bottle body, a protective cap rotatably covered over the bottle cap, and a nursing time indicating device including an indicating sign and a scale structure separately provided on the outer surfaces of the nursing bottle and the protective cap at corresponding positions; whereby the indicating sign may be aligned with a desired position of the scale structure to represent a specific time.

2. The nursing bottle with a nursing time indicating device as claimed in claim 1, further comprising a ring member located between the bottle body and the bottle cap; the ring member being immovably held around an upper portion of the bottle body below the bottle mouth when the bottle cap is tightly screwed to the bottle mouth; and the indicating sign and the scale structure being separately provided on the protective cap and the ring member at corresponding positions.

3. The nursing bottle with a nursing time indicating device as claimed in claim 1, wherein the indicating sign and the scale structure are separately provided on the protective cap and the bottle cap at corresponding positions.

4. The nursing bottle with a nursing time indicating device as claimed in claim 1, wherein the indicating sign and the scale structure are separately provided on the protective cap and the bottle body at corresponding positions.

5. The nursing bottle with a nursing time indicating device as claimed in claim 2, wherein the ring member is provided at two diametrically opposite sides with two outward extended handles.

6. The nursing bottle with a nursing time indicating device as claimed in claim 1, wherein the indicating sign is in the shape of an arrow, and the scale structure includes a plurality of parallelly arranged and circumferentially equally spaced line segments.

7. The nursing bottle with a nursing time indicating device as claimed in claim 6, wherein the indicating sign and the scale structure are integrally formed on the nursing bottle during the manufacturing thereof.

8. The nursing bottle with a nursing time indicating device as claimed in claim 6, wherein the indicating sign and the scale structure are stickers.

9. The nursing bottle with a nursing time indicating device as claimed in claim 1, further comprises of a reminder in the form of a phrase.

10. A nursing bottle with a nursing time indicating device, comprising a bottle body defining a predetermined capacity, a bottle cap screwed to a mouth of the bottle body, a protective cap rotatably covered over the bottle cap, a ring member located between the bottle body and the bottle cap, and a nursing time indicating device including an indicating sign and a scale structure separately provided on the outer surfaces of the nursing bottle and the ring member at corresponding positions; whereby the indicating sign may be aligned with a desired position of the scale structure to represent a specific time.

11. The nursing bottle with a nursing time indicating device as claimed in claim 10, wherein the indicating sign and the scale structure being separately provided on the ring member and the bottle cap at corresponding positions.

12. The nursing bottle with a nursing time indicating device as claimed in claim 10, wherein the indicating sign and the scale structure being separately provided on the ring member and the bottle body at corresponding positions.

13. The nursing bottle with a nursing time indicating device as claimed in claim 11, wherein the ring member is provided at two diametrically opposite sides with two outward extended handles.

14. The nursing bottle with a nursing time indicating device as claimed in claim 12, wherein the ring member is provided at two diametrically opposite sides with two outward extended handles.

15. The nursing bottle with a nursing time indicating device as claimed in claim 10, wherein the indicating sign is in the shape of an arrow, and the scale structure includes a plurality of parallelly arranged and circumferentially equally spaced line segments.

16. The nursing bottle with a nursing time indicating device as claimed in claim 15, wherein the indicating sign and the scale structure are integrally formed on the nursing bottle during the manufacturing thereof.

17. The nursing bottle with a nursing time indicating device as claimed in claim 15, wherein the indicating sign and the scale structure are stickers.

18. The nursing bottle with a nursing time indicating device as claimed in claim 10, further comprising a reminder in the form of a phrase.

19. The nursing bottle with a nursing time indicating device as claimed in claim 2, wherein the indicating sign is in the shape of an arrow, and the scale structure includes a plurality of parallelly arranged and circumferentially equally spaced line segments.

20. The nursing bottle with a nursing time indicating device as claimed in claim 3, wherein the indicating sign is in the shape of an arrow, and the scale structure includes a plurality of parallelly arranged and circumferentially equally spaced line segments.
